(19) United States
(12) Patent Application Publication
(10) Pub. No.: US 2026/0155602 A1
(43) Pub. Date: Jun. 4, 2026

(54) CONNECTOR AND CONNECTOR ASSEMBLY

(71) Applicant: SUMITOMO WIRING SYSTEMS, LTD., Mie (JP)

(72) Inventor: Yoichi TAKAGI, Mie (JP)

(21) Appl. No.: 19/400,235

(22) Filed: Nov. 25, 2025

(30) Foreign Application Priority Data
Nov. 29, 2024 (JP) 2024-208113

(51) Int. Cl. H01R 13/627; H01R 13/641

(52) U.S. Cl. CPC H01R 13/6272; H01R 13/641

(57) ABSTRACT

A detecting member includes a base portion, a detecting piece, and a pair of holding arms. The pair of holding arms are shorter than the detecting piece in the length dimension from the base portion. A holding portion that holds the detecting member includes an upper holding portion that is provided above a lock arm with respect to a housing and holds the holding arms such that the holding arms are movable in the front-rear direction, and a lower holding portion that is provided below the lock arm with respect to the housing and holds the base portion such that the base portion is movable in the front-rear direction.

### CROSS-REFERENCE TO RELATED APPLICATIONS

This application is based on and claims priority from Japanese Patent Application No. 2024-208113, filed on Nov. 29, 2024, with the Japan Patent Office, the disclosure of which is incorporated herein in its entirety by reference.

### TECHNICAL FIELD

The present disclosure relates to a connector having a detecting member that detects a fitting state with a counterpart connector and to a corresponding connector assembly.

### BACKGROUND

In Japanese Patent Laid-Open Publication No. 2021-144787, a connector having a fitting detection function by a detecting member is described. The connector has a lock arm and a detecting member in a housing. The lock arm extends from an outer surface in a cantilevered form, and the detecting member is provided to be able to move forward in the housing to a detection position from an initial position. The detecting member includes a detecting piece that is allowed to move to the detection position when the fitting with a counterpart connector is held by the lock arm.

### SUMMARY

In general, there is a demand to downsize connectors. However, when a housing is simply downsized, a space for disposing a detecting member and a space for disposing terminals inside the connector become tight, and there is a fear that the function of the connector itself may be adversely affected. Therefore, there is room for improvement in the downsizing of the connector.

Accordingly, it is an object of the present invention to improving downsizing of a connector.

This object is solved according to the invention by the features of the independent claims. Particular embodiments of the invention are subject of the dependent claims.

According to one aspect, there is provided a connector capable of being fitted with a counterpart connector, the connector comprising: a housing having at least one lock arm configured to hold the fitting with the counterpart connector; and a detecting member configured to detect whether the fitting with the counterpart connector is held by the lock arm, wherein: the lock arm substantially extends rearward from an outer surface of the housing in a cantilevered form; the housing includes a holding portion that is provided on a rear end side and configured to hold the detecting member such that the detecting member is movable between an initial position and a detection position toward the lock arm substantially in a front-rear direction. Moreover, the detecting member includes: a base portion; at least one detecting piece that extends frontward from the base portion and that is allowed to move towards or to the detection position when the lock arm holds the fitting with the counterpart connector; and one or more holding arms that are provided in the base portion and that substantially extend frontward above the detecting piece; the one or more holding arms are shorter than the detecting piece in a length dimension from the base portion. Furthermore, the holding portion (20) includes: a first holding portion that is provided above the lock arm with respect to the housing and holds the one or more holding arms such that one or more holding arms are movable substantially in the front-rear direction; and a second holding portion that is provided below the lock arm with respect to the housing and holds the base portion (31) such that the base portion is movable substantially in the front-rear direction.

According to a particular embodiment, the connector comprises a pair of holding arms that are provided to be spaced apart from each other in a width direction intersecting with the front-rear direction in the base portion and that substantially extend frontward above the detecting piece.

According to a particular embodiment, the connector is a connector capable of being fitted with a counterpart connector. The connector includes a housing having a lock arm configured to hold the fitting with the counterpart connector, and a detecting member configured to detect whether the fitting with the counterpart connector is held by the lock arm. In the connector, the lock arm extends rearward from an outer surface of the housing in a cantilevered form, the housing includes a holding portion that is provided on a rear end side and configured to hold the detecting member such that the detecting member is movable between an initial position and a detection position toward the lock arm in the front-rear direction, the detecting member includes a base portion, a detecting piece that extends toward the lock arm from the base portion and that is allowed to move to the detection position when the lock arm holds the fitting with the counterpart connector, and a pair of holding arms that are provided to be spaced apart from each other in the width direction intersecting with the front-rear direction in the base portion and that extend frontward above the detecting piece, the pair of holding arms are shorter than the detecting piece in the length dimension from the base portion, and the holding portion includes an upper holding portion that is provided above the lock arm with respect to the housing and holds the pair of holding arms such that the pair of holding arms are movable in the front-rear direction, and a lower holding portion that is provided below the lock arm with respect to the housing and holds the base portion such that the base portion is movable in the front-rear direction.

Specifically, a connector of the present disclosure is a connector capable of being fitted with a counterpart connector. The connector includes a housing having a lock arm configured to hold the fitting with the counterpart connector, and a detecting member configured to detect whether the fitting with the counterpart connector is held by the lock arm. In the connector, the lock arm extends rearward from an outer surface of the housing in a cantilevered form, the housing includes a holding portion that is provided on the rear end side and configured to hold the detecting member such that the detecting member is movable between an initial position and a detection position toward the lock arm in a front-rear direction, the detecting member includes a base portion, a detecting piece that extends frontward from the base portion and that is allowed to move to the detection position when the lock arm holds the fitting with the counterpart connector, and a pair of holding arms that are provided to be spaced apart from each other in the width direction intersecting with the front-rear direction in the base portion and that extend frontward above the detecting piece, the pair of holding arms are shorter than the detecting piece in the length dimension from the base portion, and the holding portion includes an upper holding portion that is provided above the lock arm and that holds the pair of holding arms such that the pair of holding arms are movable in the front-rear direction, and a lower holding portion that is provided below the lock arm and that holds the base portion such that the base portion is movable in the front-rear direction.

In the connector having the configuration described above, the one or more holding arms (particularly the pair of holding arms) of the detecting member are held by the upper holding portion provided above the lock arm, and the base portion is held by the second or lower holding portion provided below the lock arm.

As a result, out of the detecting member, the one or more holding arms (particularly the pair of holding arms) are held above the lock arm provided on an upper outer surface of the connector.

Therefore, the space inside the housing can be effectively used as compared to a case in which the holding arms are held in a space below the lock arm in the housing.

In the detecting member, the one or more holding arms (particularly the pair of holding arms) and the base portion are movably held by the upper holding portion and the second or lower holding portion, respectively.

As a result, even when the length dimension of the pair of holding arms is set to be shorter than that of the detecting piece, the detecting member can be prevented from falling from the holding portion in the process of moving to the detection position from the initial position.

Here, the expression of "the detecting member falls from the holding portion" particularly means that the detecting member is moved from a state that is expected with respect to the holding portion. The same applies to the holding arms.

As a result, in accordance with the downsizing of the holding arms, the increase in the size of the first or upper holding portion provided on the upper side of the housing can be suppressed, and the connector can be downsized.

The detecting member particularly includes at least one arm supporting portion that is provided above or adjacent to the base portion and that has both ends in the width direction that each project to the outer side of the base portion.

The pair of holding arms particularly extend from the ends of the arm supporting portion in the width direction of the arm supporting portion, respectively.

By the configuration described above, the one or more holding arms (particularly the pair of holding arms) can be smoothly moved to the detection position from the initial position inside the arm accommodation spaces by causing the one or more holding arms (particularly the pair of holding arms) to be deformed by deflection in the width direction with the starting points being both the ends of the arm supporting portion, and the operability of the detecting member can be improved.

Particularly, the housing includes a deflection space at least in correspondence with or below the lock arm.

The deflection space particularly tolerates deflection deformation of the lock arm in the up-down direction.

Further particularly, the second or lower holding portion has a base accommodation space that at least partly accommodates the base portion and/or that communicates with the deflection space.

Further particularly, the detecting piece is to be positioned at least partly inside the deflection space at the initial position, and the length dimension of the detecting piece in the width direction is desired to be shorter than a separation distance between the pair of holding arms in the width direction.

By the configuration described above, it becomes possible to make the space necessary for the entry of the detecting piece of the detecting member inside the housing compact even with a configuration in which the detecting piece is positioned at least partly inside the deflection space of the connector at the initial position.

As a result, the space below the lock arm in the housing can be used even more effectively.

Further particularly, the one or more holding arms (particularly the pair of holding arms) preferably each include a main locking protrusion that projects to the inner side in the width direction, and a deflection restricting protrusion that is provided behind the main locking protrusion and projects to the outer side in the width direction.

Further particularly, the first or upper holding portion preferably includes an inner-side wall provided on the inner side relative to each of the one or more holding arms (particularly the pair of holding arms), and an outer-side wall provided on the outer side relative to each of the one or more holding arms (particularly the pair of holding arms).

Further particularly, an arm accommodation space in which each of the one or more holding arms (particularly the pair of holding arms) is accommodated is preferably formed in a space sandwiched between the inner-side wall and the outer-side wall.

The inner-side wall particularly includes a wall side protrusion that projects to the outer side in the width direction.

The one or more holding arms (particularly the pair of holding arms) particularly each reach the detection position from the initial position as a result of the main locking protrusion riding over the wall side protrusion by being deformed by deflection on the outer side in the width direction in a state in which the deflection restricting protrusion is in abutment against the outer-side wall inside the arm accommodation space.

In the configuration described above, by the pushing operation against the detecting member, the one or more holding arms (particularly the pair of holding arms) are deformed by deflection toward the outer sides inside the arm accommodation spaces.

As a result, the main locking protrusions ride over the wall side protrusions of the first or upper holding portion, and the one or more holding arms (particularly the pair of holding arms) reach the detection position from the initial position.

At this time, the deflection restricting protrusions of the one or more holding arms (particularly the pair of holding arms) particularly hit the outer-side walls of the first or upper holding portion.

As a result, a large deflection deformation of the one or more holding arms (particularly the pair of holding arms) in the width direction can be prevented, and cases in which the holding arms fall from the first or upper holding portion can be suppressed.

According to the present disclosure, it becomes possible to effectively use the space below the lock arm in the housing and contribute to the downsizing of the connector.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector seen from the front at an angle.

FIG. 2 is a plan view of the connector seen from above.

FIG. 3 is a rear view of the connector seen from the rear.

FIG. 4 is a perspective view of a detecting member seen from the front at an angle.

FIG. 5 is a cross-sectional view showing a housing main body taken along the position of C-C in FIG. 3 while omitting the illustration of the detecting member.

FIG. 6 is a cross-sectional view showing the housing main body taken along the position of B-B in FIG. 3 while omitting the illustration of the detecting member.

FIG. 7 is a cross-sectional view showing the housing main body taken along the position of A-A in FIG. 2 in a state in which a counterpart connector and the connector are half-fitted.

FIG. 8 is a cross-sectional view showing the housing main body taken along the position of B-B in FIG. 3 in a state before the counterpart connector and the connector are fitted.

FIG. 9 is a cross-sectional view showing a state in which the counterpart connector and the connector are in the middle of fitting, the cross-sectional view taken along the position of C-C in FIG. 3.

FIG. 10 is a cross-sectional view showing a state in which the connector is fitted and the detecting member is in the middle of heading toward a detection position from an initial position, the cross-sectional view taken along the position of A-A in FIG. 2.

FIG. 11 is a cross-sectional view showing a state in which the connector is fitted and the detecting member has reached the detection position, the cross-sectional view taken along the position of A-A in FIG. 2.

FIG. 12 is a cross-sectional view showing a state in which the connector is fitted and the detecting member has reached the detection position, the cross-sectional view taken along the position of B-B in FIG. 3.

FIG. 13 is a cross-sectional view showing a state in which the connector is fitted and the detecting member has reached the detection position, the cross-sectional view taken along the position of C-C in FIG. 3.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

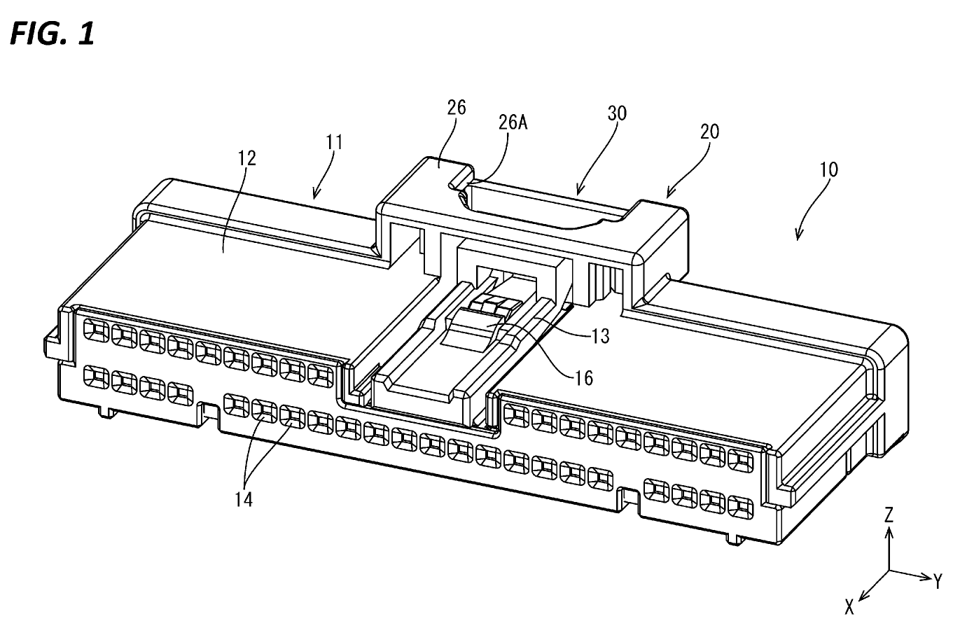

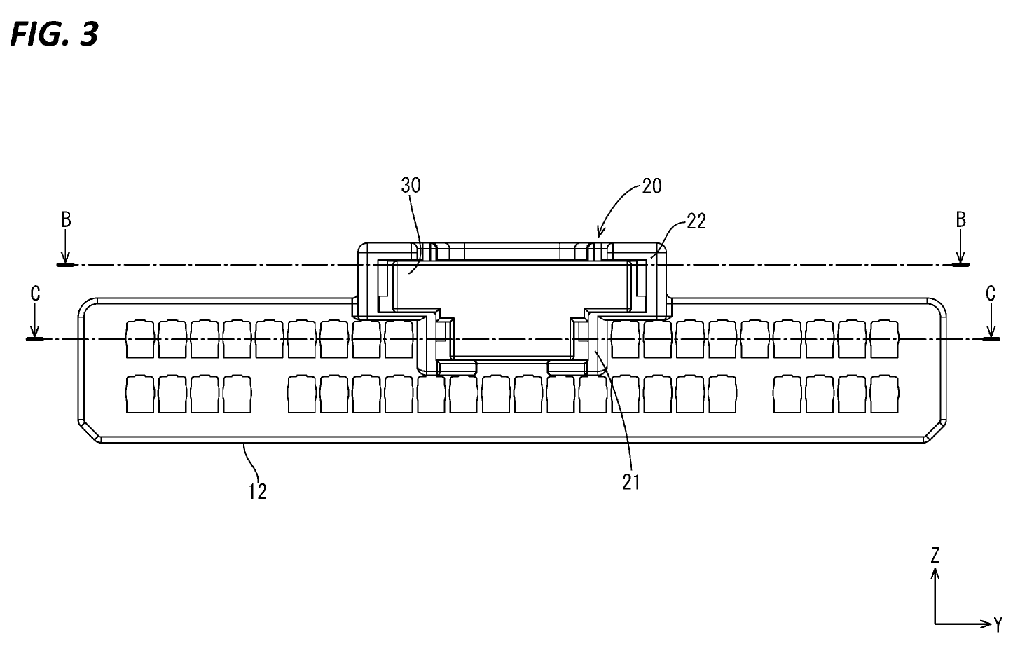

A particular embodiment of the present disclosure is described below with reference to FIGS. 1-13. The present disclosure is not limited to the exemplifications above, and is defined by the scope of claims. All modifications made within the scope and spirit equivalent to those of the claims are intended to be included in the invention. In each of the drawings, a part of a configuration may be shown in an exaggerated or simplified manner for explanatory convenience.

In the description below, description is made by considering that the direction indicated by an arrow line Z is the top, the direction indicated by an arrow line X is the front, and the direction indicated by an arrow line Y is the left. The direction in which an arrow X extends is described as a "front-rear direction X", the direction in which an arrow Y extends is described as a "width direction Y", and the direction in which an arrow Z extends is described as an "up-down direction Z". Regarding a plurality of the same members, only some members may be denoted and the reference characters of the other members may be omitted.

As shown in FIG. 1, a connector 10 includes a housing 11 at least partly to be fitted with a counterpart or mating connector 60 particularly on the front side, and at least one detecting member 30.

In the present embodiment, the housing 11 particularly is made of synthetic resin.

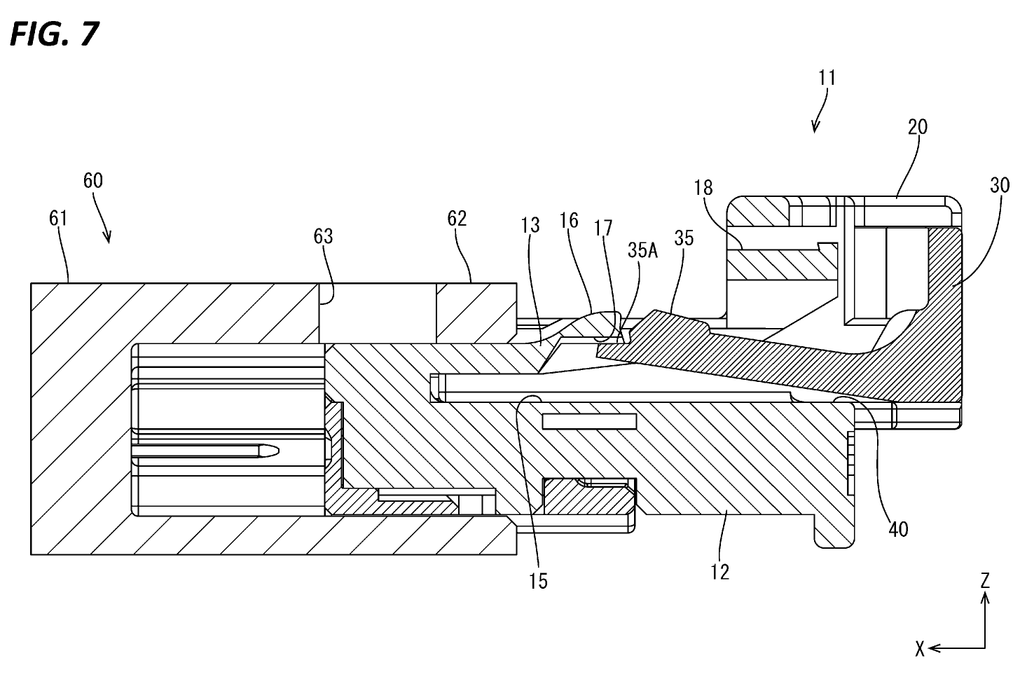

As shown in FIG. 7, the counterpart connector 60 to be at least partly fitted with the housing 11 includes a counterpart or mating housing 61 particularly made of synthetic resin.

The counterpart housing 61 specifically has a substantially cylindrical hood 62 open to the front.

At least one lock receiving portion 63 with which at least one lock arm 13 of the connector 10 described later is locked or lockable is formed on the hood 62, particularly in a front end portion of an upper or lateral wall of the hood 62.

The lock receiving portion 63 particularly is a through-hole that passes through the upper wall.

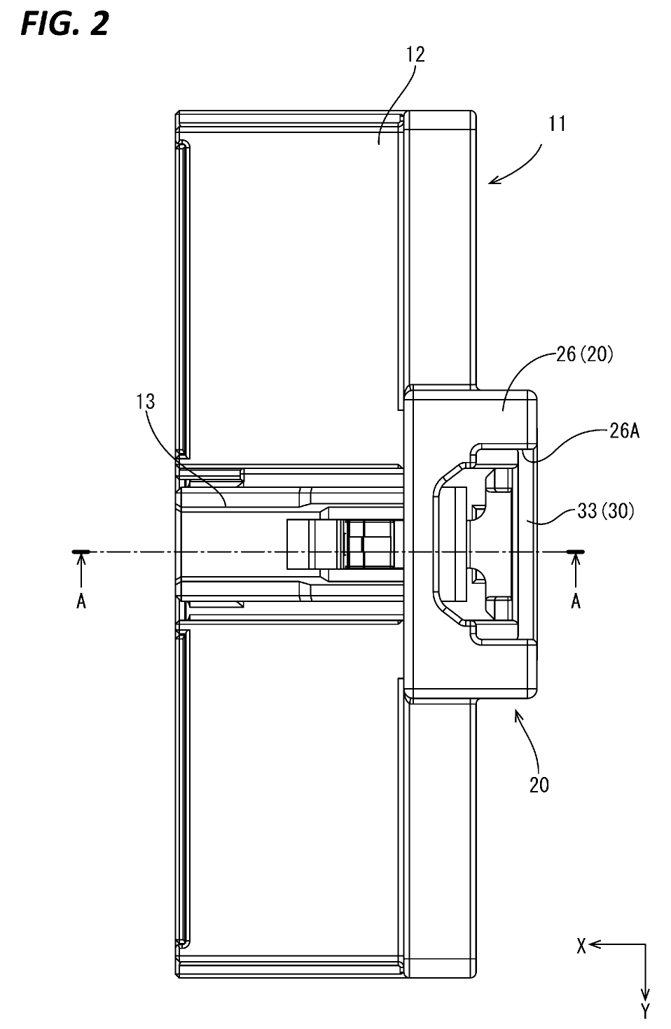

Specifically, the housing 11 includes a (particularly substantially block-shaped) housing main body 12, the at least one lock arm 13 integrally or unitarily coupled to (particularly an upper outer surface of) the housing main body 12, and/or at least one holding portion 20 that particularly is provided on (particularly the rear end side of) the housing main body 12 and/or that holds or can hold the detecting member 30 as shown in FIGS. 1 and 2.

One or more, particularly a plurality of terminal accommodation compartments 14 in which one or more terminals at least partly are or can be accommodated are formed inside the housing main body 12.

The one or more terminal accommodation compartments 14 particularly are spaces that pass through the housing main body 12 substantially in the front-rear direction X.

In the present embodiment, the terminal accommodation compartments 14 particularly are formed to be arrayed in the width direction Y and/or the up-down direction Z inside the housing main body 12.

In substantially the center of the housing main body 12 in the width direction Y, the lock arm 13 and a deflection space 15 (shown in FIG. 7) that tolerates the deflection of the lock arm 13 in the lateral (particularly up-down) direction particularly are formed. Specifically, the terminal accommodation compartments 14 arrayed on the upper side are formed to be arrayed on the left and the right across the lock arm 13 in the width direction Y.

The lock arm 13 specifically is a section that extends substantially along the front-rear direction X (particularly substantially from the front to the rear of the housing main body 12) in a cantilevered form on (particularly the upper or lateral outer surface of) the housing main body 12. In other words, the lock arm 13 is configured to substantially be deflectable in the up-down direction Z (or in a direction intersecting the connection of the connector 10 with the counterpart connector 60) particularly with the front side of the housing main body 12 being a proximal end portion.

At least one lock protrusion 16 projecting upward particularly is provided on the lock arm 13.

The lock protrusion 16 specifically is a section to be at least partly inserted into the lock receiving portion 63 when the connector 10 is fitted with the counterpart connector 60.

As shown in FIG. 7, at least one accommodating recessed portion 17 that is open on the lower or inner side is provided in the lock protrusion 16.

An upper distal end of the detecting piece 32 of the detecting member 30 described later particularly at least partly is accommodated or accommodatable in the accommodating recessed portion 17.

In the lock arm 13, at least one release operation portion 18 particularly is provided behind the lock protrusion 16.

The release operation portion 18 specifically is a section that accepts a pressing operation for releasing the fitting with the counterpart connector 60 for the lock arm 13.

In the housing main body 12, the deflection space 15 for tolerating or accommodating the elastic deflection of the lock arm 13 in the process in which the connector 10 and the counterpart connector 60 are fitted with each other particularly is formed below (or in a deflection direction) the lock arm 13.

As shown in FIG. 7, the deflection space 15 specifically is a space that substantially extends rearward in the housing main body 12 from the distal end side thereof, and/or communicates with a base accommodation space 40 of the holding portion 20 described later on the rear of the housing main body 12.

As shown in FIG. 1, the holding portion 20 in which the detecting member 30 at least partly is inserted and held particularly is provided on (particularly the rear end side of) the housing main body 12.

The holding portion 20 specifically is a section that is positioned in the substantially center in the width direction Y on (particularly the rear end side of) the housing main body 12 and/or that projects upward and rearward relative to the housing main body 12.

The rear side of the holding portion 20 particularly is open.

By at least partly inserting the detecting member 30 into this opening, the holding portion 20 can hold the detecting member 30 such that the detecting member 30 can be moved in the front-rear direction X.

The detecting member 30 particularly is a member that detects or can detect whether the fitting of the lock arm 13 of the connector 10 with the counterpart connector 60 is held or kept.

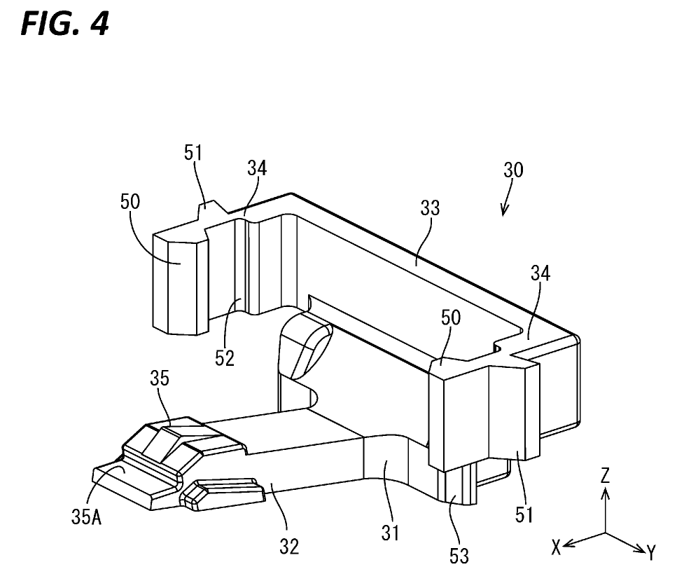

As shown in FIG. 4, the detecting member 30 includes a base portion 31, the at least one detecting piece 32 that substantially extends frontward from the base portion 31, an operation portion 33 (particularly provided above the base portion 31), and/or one or more, particularly a pair of holding arms 34.

Specifically, the pair of holding arms 34 are provided to be spaced apart from each other in the width direction that intersects with the (forward) direction in which in the detecting piece 32 extends.

In the present embodiment, the detecting member 30 particularly is integrally or unitarily formed by synthetic resin.

Specifically, the one or more, particularly the pair of holding arms 34 are elastically deformable.

The base portion 31 particularly is a section that substantially is movable along a bottom surface of the holding portion 20 and/or particularly has a substantially rectangular shape in plan view.

The detecting piece 32 that extends to the front particularly is provided on the base portion 31.

Specifically, the detecting piece 32 substantially extends diagonally upward or inward from the base portion 31 at a specified (predetermined or predeterminable) angle and/or a distal end thereof substantially has a raised form.

At least one detecting protrusion 35 to be engaged with the lock protrusion 16 of the lock arm 13 particularly is provided on the distal end of the detecting piece 32.

An abutting portion 35A substantially projecting to the front is provided on (particularly the distal end of) the detecting protrusion 35.

Specifically, the abutting portion 35A is a section that abuts against (particularly a bottom surface of) the lock protrusion 16 at a standby position as described later.

The operation portion 33 (particularly substantially having a plate-like shape and/or substantially extending in the width direction Y) is provided above the base portion 31.

The operation portion 33 particularly is a section for moving the detecting member 30 to be slid in the front-rear direction X e.g. by hooking a finger or a jig thereon.

The operation portion 33 particularly has a larger dimension in the width direction Y than the base portion 31, and/or both ends thereof project in the width direction Y relative to the base portion 31.

The one or more, particularly the pair of holding arms 34 are provided on one or both of the ends of the operation portion 33 in the width direction Y.

The holding arms 34 particularly substantially extend in a cantilevered form from (particularly one or both of the ends of) the operation portion 33 to the front such that the thickness direction thereof substantially faces the width direction Y.

The one or more holding arms 34 particularly are able to be deformed by deflection in the width direction Y with particularly one or both of the ends of) the operation portion 33 being points of support.

The length dimension of the one or more, particularly the pair of holding arms 34 from the operation portion 33 particularly is shorter than the length dimension of the detecting piece 32 from the base portion 31.

In the present embodiment, the operation portion 33 is one example of an arm supporting portion.

On the distal end of the holding arm 34 (particularly on each of distal ends of the holding arms 34), a main locking protrusion 50 substantially projecting to the inner side in the width direction Y, and/or an upper falling prevention protrusion 51 (specifically being provided behind the main locking protrusion 50 and/or projecting to the outer side in the width direction Y) particularly are provided.

The dimension that projects in the width direction Y particularly is longer in the upper falling prevention protrusion 51 than in the main locking protrusion 50.

The upper falling prevention protrusion 51 particularly has a shape in which the front side is inclined.

At least one locking groove 52 particularly is provided on the inner side in the width direction Y behind the main locking protrusion 50 in the holding arm 34.

In the present embodiment, the upper falling prevention protrusion 51 particularly is positioned on the distal end side of the holding arm 34, and/or the distance from the main locking protrusion 50 particularly is short.

Specifically, the locking groove 52 is positioned under a neck part of the main locking protrusion 50 in the front-rear direction X and/or (also) functions as a thin-walled portion by the holding arm 34.

In the present embodiment, the upper falling prevention protrusion 51 is one example of a deflection restricting protrusion.

One or more, particularly a pair of lower falling prevention protrusions 53 projecting to the outer sides in the width direction Y particularly are provided on the base portion 31.

Specifically, the lower falling prevention protrusions 53 each have a shape in which the front side is inclined. The one or more lower falling prevention protrusions 53 particularly are sections for preventing the detecting member 30 from falling from the holding portion 20 with the upper falling prevention protrusions 51.

Next, a detailed configuration of the holding portion 20 particularly included in the housing 11 is described.

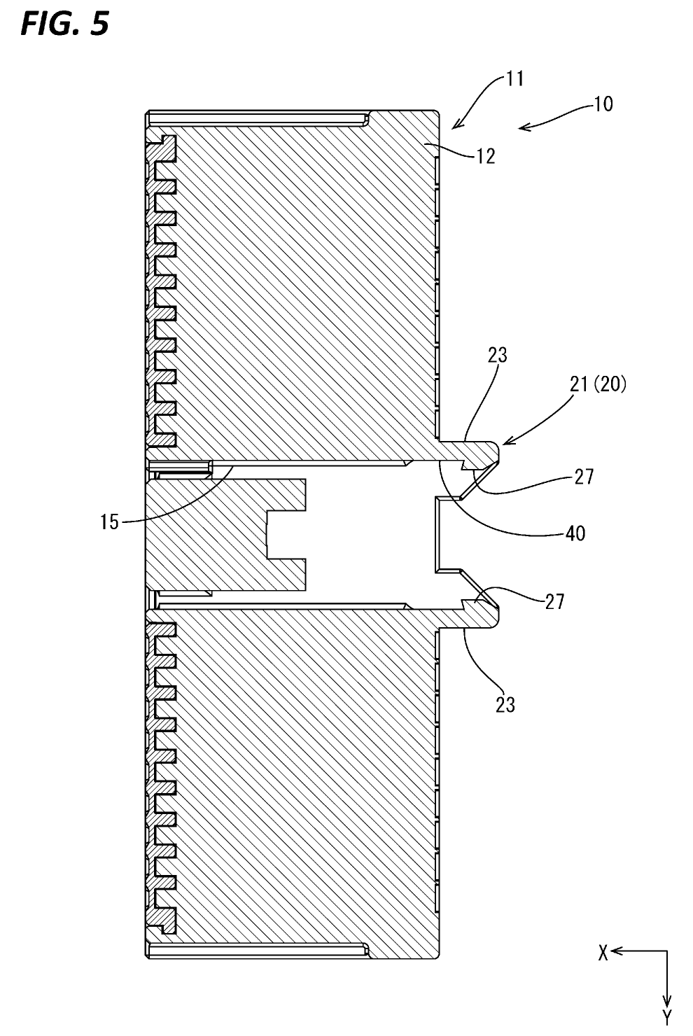

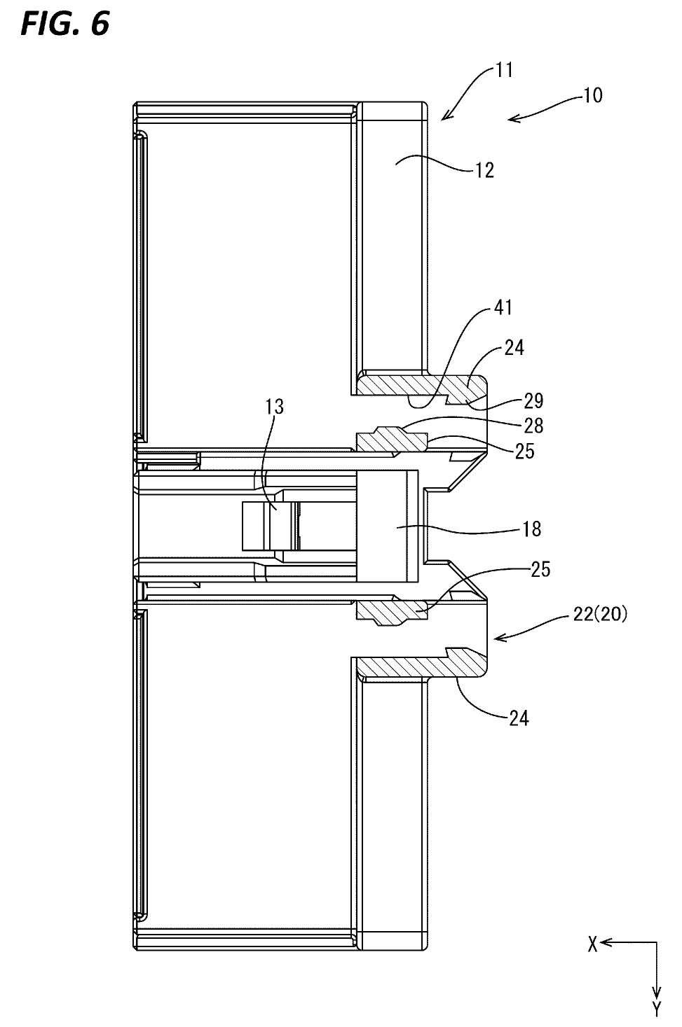

As shown in FIGS. 5 and 6, the holding portion 20 particularly includes a lower holding portion 21 in which the base portion 31 of the detecting member 30 is held so as to be movable in the front-rear direction X, and/or an upper holding portion 22 which is positioned above the lower holding portion 21.

Particularly, in the upper holding portion 22 the one or more, particularly the pair of holding arms 34 are held so as to be movable in the front-rear direction X.

As shown in FIG. 5, the lower holding portion 21 particularly includes one or more, particularly a pair of lower holding walls 23 that substantially rise from a bottom wall in the up-down direction Z.

Specifically by providing the pair of lower holding walls 23 to be spaced apart from each other by a distance substantially in accordance with the dimension of the base portion 31 in the width direction Y, the base accommodation space 40 in which the base portion 31 is accommodated is or can be formed inside thereof.

The base accommodation space 40 particularly communicates with the deflection space 15 provided inside the housing main body 12 in the front-rear direction X.

At least one lower locking portion 27 that specifically is a protrusion projecting to the inner side in the width direction Y particularly is provided on a rear end side of (particularly each of) the lower holding wall(s) 23.

The one or more lower locking portions 27 particularly are sections for preventing the detecting member 30 from falling from the base accommodation space 40 by being locked with the lower falling prevention protrusions 53 provided on the base portion 31 of the detecting member 30.

As shown in FIG. 6, the upper holding portion 22 particularly includes one or more, particularly a pair of outer-side walls 24 rising upward from (particularly an upper outer surface of) the housing main body 12, and/or one or more, particularly a pair of inner-side walls 25 that are positioned on the inner side of the outer-side walls 24, respectively, and rise upward from (particularly the upper outer surface of) the housing main body 12.

The upper holding portion 22 particularly has a ceiling wall 26 (shown in FIG. 2) installed on (particularly upper ends of) the or each inner-side wall 25 and/or the or each outer-side walls 24 particularly in a substantially continuous manner.

The ceiling wall 26 particularly is horizontal and forms a flat-plate-like shape.

A cut-out portion 26A cut out (particularly in a substantially semicircular shape) specifically is included in the ceiling wall 26 on the rear end side thereof.

Each outer-side wall 24 particularly also functions as a side wall of the holding portion 20 by being provided to be spaced apart from each other by a specified (predetermined or predeterminable) distance in the width direction Y.

The separation distance between the outer-side walls 24 particularly is a distance substantially in accordance with the maximum dimension of the detecting member 30 in the width direction Y (in other words, the dimension between the pair of holding arms 34).

The inner-side walls 25 particularly are provided to be spaced apart from each other in the width direction Y so as to avoid the release operation portion 18 of the lock arm 13.

In the present embodiment, the separation distance between the inner-side walls 25 is substantially the same distance as the separation distance between the lower holding walls 23 that has been already described.

As a result, the connector 10 particularly has a shape in which the release operation portion 18 of the lock arm 13 is disposed in a space at least partly surrounded by the one or more, particularly the pair of the inner-side walls 25 and the ceiling wall 26 in the holding portion 20.

Specifically, the release operation portion 18 can be operated from the cut-out portion 26A of the ceiling wall 26 on the rear end side thereof.

At least one arm accommodation space 41 in which the (particularly each) holding arm 34 of the detecting member 30 at least partly is inserted or insertable and/or held or holdable particularly is formed between the outer-side wall 24 and the inner-side wall 25.

The arm accommodation space 41 particularly is also a space that spreads by a distance substantially in accordance with the thickness dimension of the holding arm 34 in the width direction Y and/or particularly substantially extends in the front-rear direction X.

As shown in FIG. 6, a rear end position of the inner-side wall 25 in the front-rear direction X particularly is in a position that is deeper than a rear end position of the outer-side wall 24. As a result, by inserting the one or more, particularly the pair of holding arms 34 of the detecting member 30 between the outer-side walls 24 particularly while causing the pair of holding arms 34 to be deformed by deflection the inner side and then causing the inner-side walls 25 to substantially abut against the holding arms 34 from the inner side, the pair of holding arms 34 can be spread to the outer sides and/or can be at least partly accommodated in the arm accommodation spaces 41.

As shown in FIG. 6, a first upper locking portion 28 that projects to the outer side in the width direction Y particularly is provided on (particularly each of) the inner-side wall(s) 25.

A second upper locking portion 29 that projects to the inner side in the width direction Y particularly is provided on (particularly each of) the outer-side wall(s) 24.

Specifically, the second upper locking portion 29 is provided on the rear side of the first upper locking portion 28 in the front-rear direction X.

In the present embodiment, the first upper locking portion 28 is one example of a wall side protrusion.

In the connector 10 having the configuration described above, the detecting member 30 particularly at least partly is inserted or insertable into the holding portion 20 from the rear side. As a result, the base portion 31 at least partly is accommodated and/or held in the base accommodation space 40 of the lower holding portion 21.

Further, the one or more holding arms 34 particularly at least partly are accommodated and/or held in the arm accommodation spaces 41 of the upper holding portion 22.

As a result, the detecting member 30 particularly is held in the initial position.

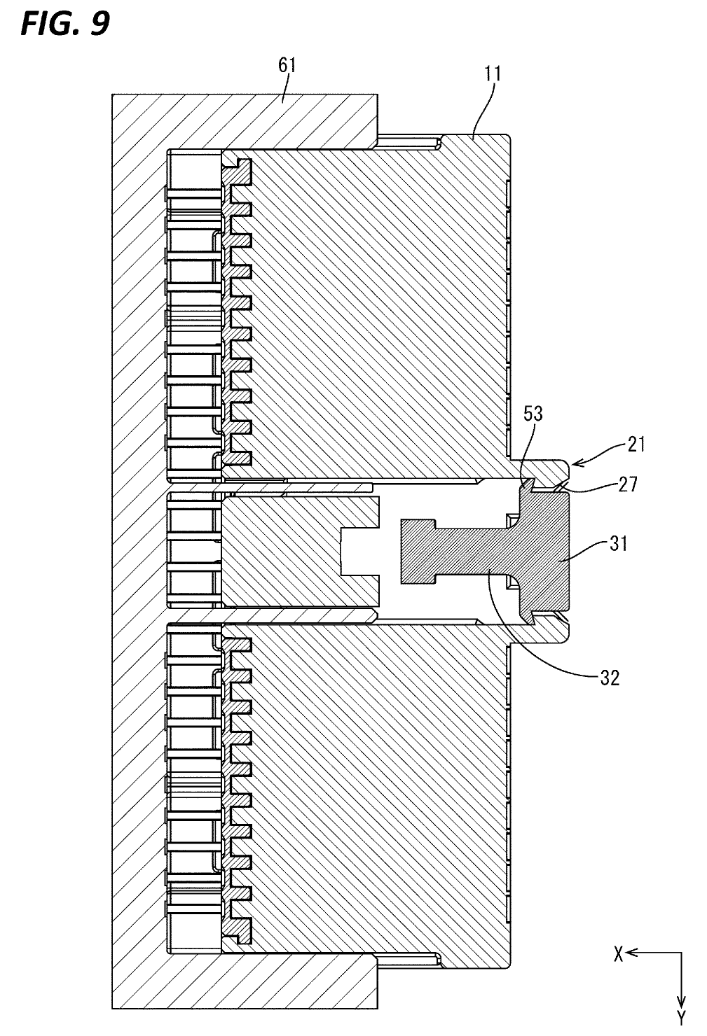

At this time, in the lower holding portion 21, the pair of lower holding walls 23 particularly are deformed by deflection toward the outer sides in accordance with the insertion of the detecting member 30. As a result, the one or more lower falling prevention protrusions 53 of the base portion 31 ride over the lower locking portions 27, and/or the base portion 31 is held in a position shown in FIG. 9 in the base accommodation space 40.

In the upper holding portion 22, the pair of holding arms 34 particularly at least partly are accommodated into the near side in the upper holding portion 22 while being deformed by deflection to the inner side and then are pushed out to the outer sides by the inner-side walls 25.

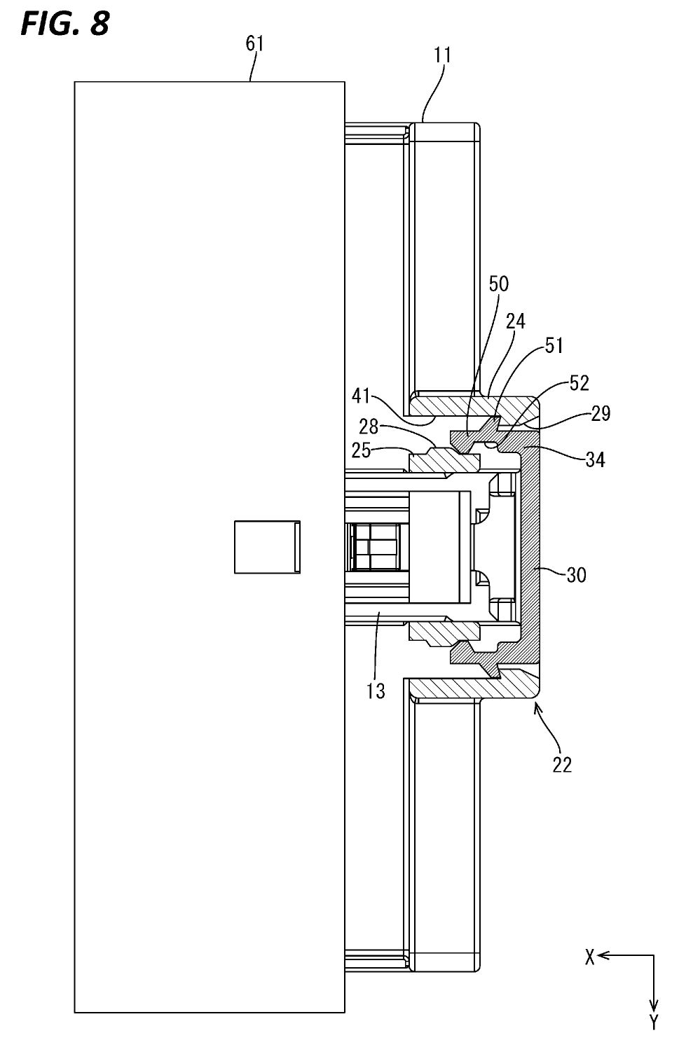

As a result, the pair of holding arms 34 particularly at least partly are inserted into the arm accommodation spaces 41 between the outer-side walls 24 and the inner-side walls 25 shown in FIG. 8.

As shown in FIG. 8, at the initial position, in the arm accommodation spaces 41 of the upper holding portion 22, distal end sides of the main locking protrusions 50 of the holding arms 34 particularly substantially abut against the first upper locking portions 28, and/or the holding arms 34 particularly are restricted from moving forward.

As shown in FIGS. 8 and 9, the upper falling prevention protrusions 51 specifically ride over the second upper locking portions 29, and/or the lower falling prevention protrusions 53 specifically ride over the lower locking portions 27, and hence the detecting member 30 particularly is prevented from falling from the holding portion 20 to the rear.

As shown in FIG. 7, at the initial position, the abutting portion 35A positioned at the distal end of the detecting protrusion 35 abuts against the lock protrusion 16 in the lock arm 13 from below in the deflection space 15.

### Description of Operation of Connector while Fitting is Continued

Next, the operation of each portion when the connector 10 is fitted with the counterpart or mating connector 60 is described.

In a fitting process in which the housing main body 12 at least partly is fitted into the hood 62 of the counterpart housing 61, the deflection deformation of the lock arm 13 and/or the detecting piece 32 to the lower side is started particularly as a result of the lock protrusion 16 of the lock arm 13 being pressed (particularly down or inward) by an inner wall of the hood 62 of the counterpart housing 61 as shown in FIG. 7.

As the fitting with the counterpart housing 61 progresses, the lock protrusion 16 particularly is pushed by the hood 62, and/or the lock arm 13 particularly is pressed down or inward to the deflection space 15.

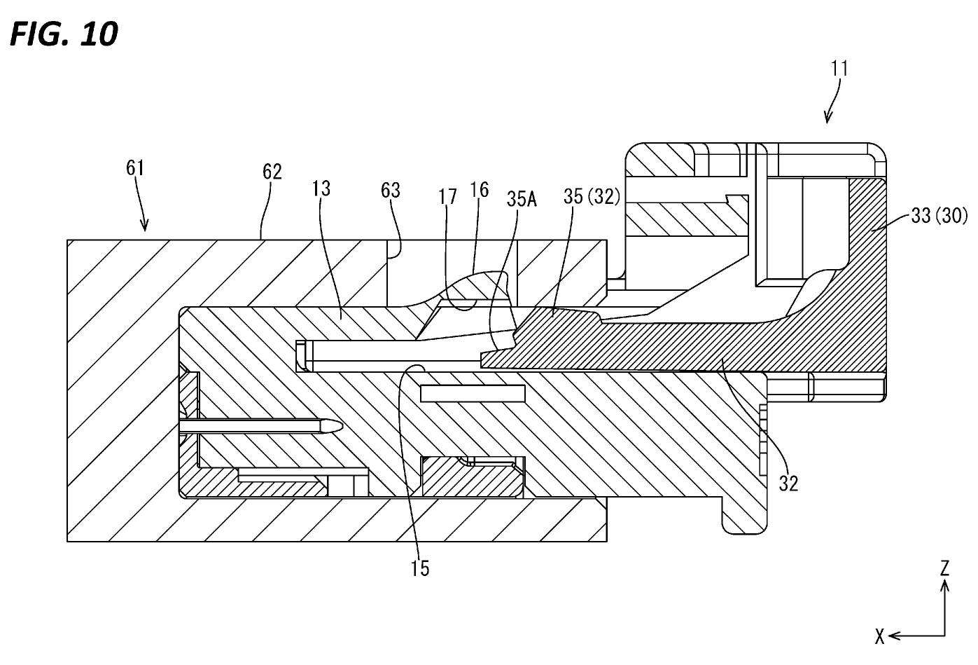

When the housing 11 substantially is properly fitted with the counterpart housing 61, the state of pressing of the hood 62 against the lock protrusion 16 particularly is released, and the lock arm 13 at least partly elastically or resiliently returns and the lock protrusion 16 at least partly enters the lock receiving portion 63 from below as shown in FIG. 10.

As a result, both the housings 11, 61 are held in a properly fitted state by the lock arm 13.

In a properly fitted state, the detecting protrusion 35 of the detecting piece 32 particularly is displaced or pushed downward by the hood 62, and/or the abutment between the abutting portion 35A and the lock protrusion 16 substantially is released.

As a result, in the detecting member 30, the detecting protrusion 35 of the detecting piece 32 particularly is detached from the lock arm 13 and/or retained at a standby position substantially in abutment with the counterpart housing 61.

At the standby position, the detecting piece 32 particularly is deformed by deflection by the hood 62 and/or is placed in an inclined posture close to being horizontal.

When a force pushing to the front is applied to the detecting member 30 at the standby position e.g. by a pressing operation to the operation portion 33, the distal end side of the detecting protrusion 35 particularly slips into a place below the lock protrusion 16 of the lock arm 13, and/or the detecting piece 32 particularly is further deformed by deflection downward.

As a result, it particularly becomes possible for the detecting piece 32 to further move forward, and/or the detecting protrusion 35 particularly at least partly is inserted into the accommodating recessed portion 17 of the lock arm 13.

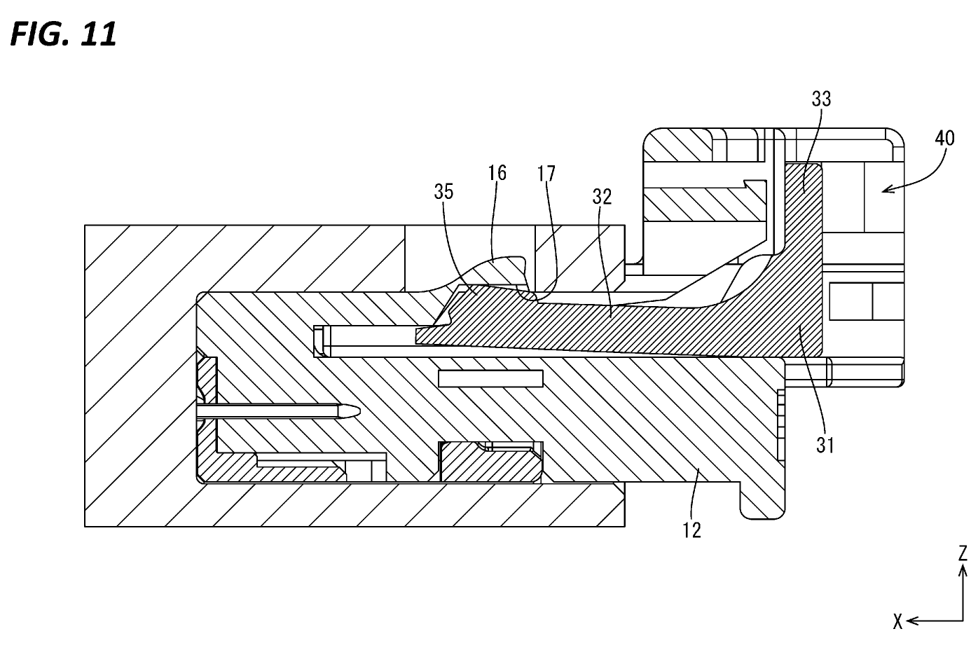

As shown in FIG. 11, as a result of the detecting protrusion 35 being at least partly accommodated in the accommodating recessed portion 17 of the lock arm 13, the detecting member 30 particularly reaches the detection position. In other words, the detecting member 30 particularly is allowed to slide to the detection position.

From this point on, even when the pressing operation is continued e.g. against the operation portion 33 of the detecting member 30, the detecting protrusion 35 particularly substantially abuts against a front surface of an inner wall of the accommodating recessed portion 17 of the lock arm 13, and hence further forward movement of the detecting member 30 particularly is suppressed.

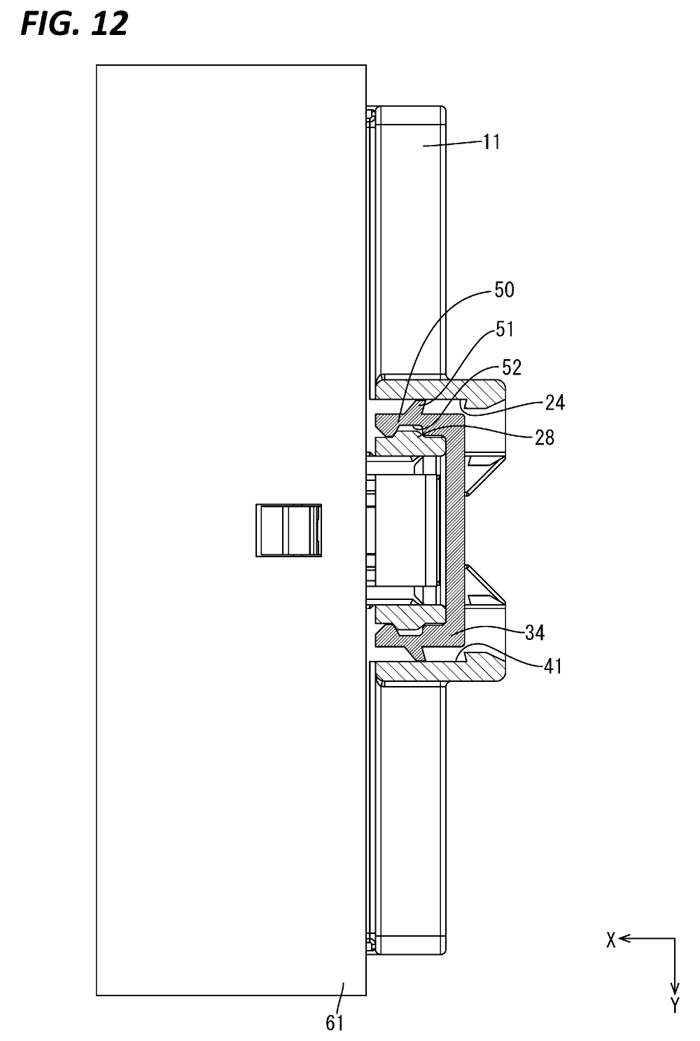

In a process in which the detecting member 30 substantially reaches the detection position from the initial position, the one or more, particularly the pair of holding arms 34 particularly are deformed by deflection to the outer sides in the width direction Y inside the arm accommodation spaces 41, and/or the one or more main locking protrusions 50 substantially ride over the first upper locking portions 28 and/or are placed in positions shown in FIG. 12 inside the arm accommodation spaces 41.

At this time, the distal end side of each of the upper falling prevention protrusions 51 particularly hits the outer-side wall 24.

As a result, it particularly becomes easier for the holding arm(s) 34 to be deformed by deflection in the width direction Y with the starting point being the locking groove 52 (in other words, the thin-walled portion) positioned below a neck part of the main locking protrusion 50.

As a result, a large deflection deformation of the holding arms 34 in the width direction Y inside the arm accommodation spaces 41 particularly can be suppressed.

As a result, the holding arms 34 particularly can be prevented from falling from the upper holding portion 22 due to the locking of the upper holding portion 22 with respect to the holding arms 34 becoming weaker before and after the main locking protrusions 50 substantially ride over the first upper locking portions 28.

As a result of the detecting member 30 reaching the detection position, the first upper locking portion(s) 28 particularly at least partly is/are inserted into the locking groove(s) 52 in the holding arms 34, and/or the holding arm(s) 34 particularly is/are restricted from moving forward in the arm accommodation space(s) 41 as shown in FIG. 12.

As a result, the downward deflection operation of the lock arm 13 particularly is suppressed by the detecting member 30.

Thus, the proper fitting between both the housings 11, 61 is firmly held or locked.

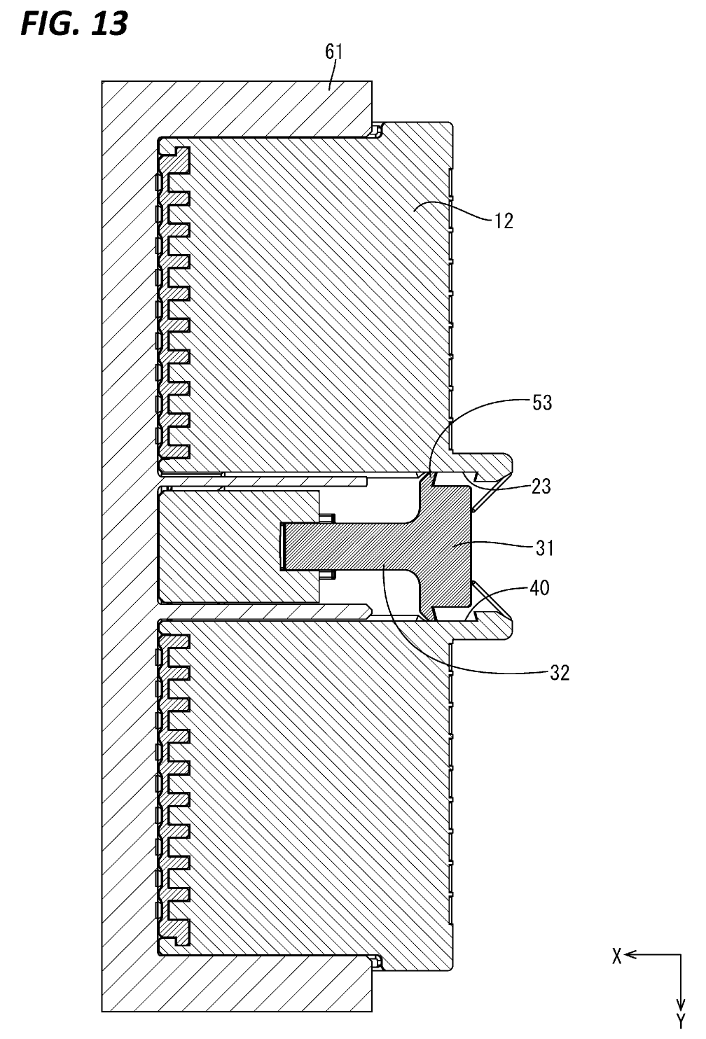

In a process in which the detecting member 30 reaches the detection position from the initial position, the base portion 31 of the detecting member 30 particularly moves forward to the position shown in FIG. 13 inside the base accommodation space 40.

Here, it particularly is difficult for the base portion 31 to be deformed by deflection as compared to the holding arms 34. Therefore, the base portion 31 moves forward while substantially abutting, as appropriate, against the lower holding wall 23 at distal ends of the lower falling prevention protrusions 53 projecting from both ends in the width direction Y.

Meanwhile, when the housing 11 remains improperly or half-fitted without being properly fitted with the counterpart housing 61, the lock arm 13 particularly is placed in a state maintained to be deformed downward or inward by deflection by being pushed by the hood 62.

Therefore, even when it is attempted to push the detecting member 30 to the front, the detecting protrusion 35 of the detecting piece 32 particularly interferes with the lock protrusion 16, and/or the detecting piece 32 cannot enter the deflection space 15 provided below the lock arm 13.

As a result, the detecting member 30 is not allowed to move to the detection position.

Therefore, it becomes possible to know whether the housing 11 is properly fitted with the counterpart housing 61 depending on whether the detecting member 30 is movable to the detection position.

When both the housings 11, 61 in a properly fitted state are to be separated from each other, specifically first, a finger or a jig is placed on the operation portion 33 of the detecting member 30, and the detecting member 30 is pulled to the rear in that state.

A tensile force to the rear particularly is applied to the detecting member 30. As a result, the detecting member 30 is pulled back to the initial position.

Then, the finger or the jig particularly at least partly is inserted or insertable into the cut-out portion 26A provided in the ceiling wall 26 of the holding portion 20, and the release operation portion 18 particularly is operated by being pushed downward.

By performing the releasing operation against the release operation portion 18, the lock arm 13 is elastically or resiliently deflected downward or inward, the lock protrusion 16 is detached from the lock receiving portion 63, and/or the engagement state between the lock arm 13 and the lock receiving portion 63 is released.

Then, the housing 11 particularly is or can be pulled apart from the counterpart housing 61 while the release operation portion 18 is maintained in a state of being pressed down.

As a result, both the housings 11, 61 are or can be separated from each other.

### Operations and Effects of Embodiment

(1) In the connector 10, the pair of holding arms 34 of the detecting member 30 particularly are held by the upper holding portion 22 provided above the lock arm 13, and the base portion 31 is held by the lower holding portion 21 provided below the lock arm 13.

As a result, out of the detecting member 30, the pair of holding arms 34 particularly are held above or in correspondence to the lock arm 13 provided on the upper outer surface of the connector 10.

Therefore, the space inside the housing 11 particularly can be effectively used as compared to a case in which the holding arms 34 are held in a space below the lock arm 13 in the housing 11.

In the detecting member 30, the one or more, particularly the pair of holding arms 34 and the base portion 31 particularly are held by the upper holding portion 22 and the lower holding portion 21, respectively.

As a result, even when the length dimension of the pair of holding arms 34 particularly is set to be shorter than that of the detecting piece 32, the detecting member 30 can be prevented from falling from the holding portion 20 in the process of moving to the detection position from the initial position.

As a result, in accordance with the downsizing of the holding arms 34, the increase in the size of the upper holding portion 22 provided on the upper side of the housing 11 can be suppressed, and the connector 10 can be downsized.

(2) The operation portion 33 of the detecting member 30 particularly is provided above the base portion 31 and/or particularly has both ends in the width direction Y that project to the outer sides than the base portion 31.

Moreover, the pair of holding arms 34 particularly extend to the front from both of the ends of the operation portion 33 in the width direction thereof.

As a result, the one or more, particularly the pair of holding arms 34 can be smoothly moved to the detection position from the initial position at least partly inside the arm accommodation spaces 41 by causing the one or more, particularly the pair of holding arms 34 to be deformed by deflection in the width direction Y with the starting points being both of the ends of the operation portion 33, and the operability of the detecting member 30 can be improved.

(3) The detecting piece 32 of the detecting member 30 particularly at least partly is positioned in the deflection space 15 at the initial position and/or particularly has a dimension in the width direction that is shorter than the separation distance between the pair of holding arms 34 in the width direction Y.

As a result, the increase in the space necessary for the entry of the detecting piece 32 in the deflection space 15 provided inside the housing 11 particularly can be suppressed, and/or the space below the lock arm particularly can be used even more effectively in the housing 11.

(4) By the pushing operation against the detecting member 30, each of the pair of holding arms 34 particularly is deformed by deflection toward the outer side inside the arm accommodation space 41, and/or the main locking protrusion 50 particularly rides over the first upper locking portion 28 of the upper holding portion 22.

As a result, each of the pair of holding arms 34 reaches the detection position from the initial position.

At this time, the second upper locking portions 29 (deflection restricting protrusions) particularly provided on the outer sides of the pair of holding arms 34 substantially hit the inner sides of the outer-side walls 24 of the upper holding portion 22.

As a result, a large deflection deformation of the holding arms 34 in the width direction Y particularly can be prevented, and/or cases in which the holding arms 34 fall from the upper holding portion 22 particularly can be suppressed.

Accordingly, there is provided a connector that can effectively use a space in a housing and contribute to the downsizing of a connector is provided. A detecting member 30 includes a base portion 31, a detecting piece 32, and a pair of holding arms 34. The pair of holding arms 34 are shorter than the detecting piece 32 in the length dimension from the base portion 31. A holding portion 20 that holds the detecting member 30 includes an upper holding portion 22 that is provided above a lock arm 13 with respect to a housing 11 and holds the holding arms 34 such that the holding arms 34 are movable in the front-rear direction, and a lower holding portion 21 that is provided below the lock arm 13 with respect to the housing 11 and holds the base portion 31 such that the base portion 31 is movable in the front-rear direction.

### Other Embodiments

The embodiment described above can be carried out by being changed as below. The embodiment described above and modified examples below can be carried out by being combined with each other without being technically inconsistent.

In the embodiment described above, the main locking protrusion 50 and the upper falling prevention protrusion 51 particularly are provided on each of both sides of the pair of holding arms 34 in the width direction Y.

Instead, two or more protrusions may be provided on both sides of the pair of holding arms 34 in the width direction Y.

It is possible for the pair of holding arms 34 to only include the main locking protrusions 50, and the pair of holding arms 34 do not necessarily need to include the upper falling prevention protrusions 51.

In the embodiment described above, the lock arm 13 particularly is formed on the upper outer surface of the housing main body 12.

However, the lock arm 13 only may be formed on an outer surface of the housing main body 12 and/or may be formed on a side surface or a lower surface of the housing main body 12.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector capable of being fitted with a counterpart connector, the connector comprising:
a housing having at least one lock arm configured to hold the fitting with the counterpart connector;
a detecting member configured to detect whether the fitting with the counterpart connector is held by the lock arm, wherein:
the lock arm substantially extends rearward from an outer surface of the housing in a cantilevered form;
the housing includes a holding portion that is provided on a rear end side and configured to hold the detecting member such that the detecting member is movable between an initial position and a detection position toward the lock arm substantially in a front-rear direction;
the detecting member includes:
a base portion;
at least one detecting piece that extends frontward from the base portion and that is allowed to move towards or to the detection position when the lock arm holds the fitting with the counterpart connector;
one or more holding arms that are provided in the base portion and that substantially extend frontward above the detecting piece;
the one or more holding arms are shorter than the detecting piece in a length dimension from the base portion;
the holding portion includes:
a first holding portion that is provided above the lock arm with respect to the housing and holds the one or more holding arms such that one or more holding arms are movable substantially in the front-rear direction; and
a second holding portion that is provided below the lock arm with respect to the housing and holds the base portion such that the base portion is movable substantially in the front-rear direction.

2. The connector according to claim 1, comprising a pair of holding arms that are provided to be spaced apart from each other in a width direction intersecting with the front-rear direction in the base portion and that substantially extend frontward above the detecting piece.

3. The connector according to claim 1, wherein:
the detecting member includes at least one arm supporting portion that is provided above the base portion and that has both ends in the width direction of the arm supporting portion that each project to an outer side of the base portion.

4. The connector according to claim 3, wherein the pair of holding arms extend frontward from the ends of the arm supporting portion in the width direction of the arm supporting portion, respectively.

5. The connector according to claim 1, wherein the housing includes a deflection space at least in correspondence with the lock arm, the deflection space tolerating deflection deformation of the lock arm in an up-down direction.

6. The connector according to claim 5, wherein the second holding portion has a base accommodation space that at least partly accommodates the base portion and/or that communicates with the deflection space.

7. The connector according to claim 5, wherein the detecting piece is positioned at least partly inside the deflection space at the initial position; and
a length dimension of the detecting piece in the width direction is shorter than a separation distance between the pair of holding arms in the width direction.

8. The connector according to claim 1, wherein:
the one or more holding arms include:
at least one main locking protrusion that projects to an inner side in the width direction;
at least one deflection restricting protrusion that is provided behind the main locking protrusion and projects to the outer side in the width direction;
the first holding portion includes:
an inner-side wall provided on the inner side relative to each of the one or more holding arms;
an outer-side wall provided on the outer side relative to each of the one or more holding arms; and
an arm accommodation space in which the one or more holding arms at least partly is accommodated is formed in a space sandwiched between the inner-side wall and the outer-side wall.

9. The connector according to claim 8, wherein:
the inner-side wall includes a wall side protrusion that projects to the outer side in the width direction; and
the one or more holding arms reach the detection position from the initial position as a result of the main locking protrusion riding over the wall side protrusion by being deformed by deflection on the outer side in the width direction in a state in which the deflection restricting protrusion is in abutment against the outer-side wall inside the arm accommodation space.

10. A connector assembly comprising a connector according to claim 1 and a counterpart connector being connectable with each other.
